(19) United States
(12) Patent Application Publication
(10) Pub. No.: US 2019/0251218 A1
(43) Pub. Date: Aug. 15, 2019

(54) System and Method for Performing Isogeometric Analysis and Finite Element Analysis Using H-Splines

(71) Applicant: ECOLE POLYTECHNIQUE FEDERALE DE LAUSANNE (EPFL), Lausanne (CH)

(72) Inventors: Daniel Schmitter, Renens (CH); Pablo Garcia-Amorena, Lausanne (CH); Zsuzsanna Püspöki, Lausanne (CH); Michael Unser, Ecublens (CH)

(21) Appl. No.: 15/892,489

(22) Filed: Feb. 9, 2018

(51) Int. Cl. G06F 17/50

(52) U.S. Cl. CPC G06F 17/5018; G06F 2217/12; G06F 17/5095; G06F 17/5086

(57) ABSTRACT

A method for performing H-spline compatible isogeometric analysis (IGA) on a geometric object, the method being performed on a computer device having a memory, the method including the steps of creating an analysis suitable geometry (ASG) using H-splines from the geometric object, the geometric object being represented by H-splines, storing the analysis suitable geometry (ASG) in the memory, and performing the H-spline compatible IGA on the ASG stored in the memory of the computer device to generate the data the represents a stiffness matrix and a force vector of the H-spline compatible IGA.

FIELD OF INVENTION

The present invention relates to a system, method and device for computer-aided design (CAD), computer-aided engineering (CAE), computer-aided manufacturing (CAM) in general and computer-aided shape modeling, and more specifically to a method for performing finite element analysis (FEA) and isogeometric analysis using H-splines.

### BACKGROUND

The design of mechanical products such as machines, robots, airplanes, rockets, ships, cars, etc., requires CAD that is combined with FEA. This combination is commonly referred to as CAE, which includes CAM. CAE consists in the generation of an analysis suitable geometry (ASG) using CAD and solving a mathematical engineering problem—typically a complex set of differential equations—using FEA. This type of CAE is commonly used throughout the different manufacturing industries such as the aerospace, automotive, naval or mechanical industry.

CAE is indispensible in today's manufacturing processes because it is necessary to evaluate the physical properties of the object that is intended to be manufactured. For this purpose, an ASG must be generated from a CAD model to compute and simulate the physical parameters that have to be determined before a CAD object can be manufactured. For example, prior to manufacturing a surface part for a car, aircraft or boat, its aerodynamic properties have to be evaluated, computed and simulated as well as physical stress parameters. Similarly, in the automotive industry or machinery, the heat distribution along a surface or volume has to be evaluated on the digital CAD model before the relevant surface or volume is produced.

To model and generate an ASG, first the geometry of a model, e.g. a car, needs to be designed using CAD. The geometry consists in curves, surfaces or volumes and the most common methods to model smooth geometries are called non-uniform rational B-splines (NURBS). They have become an industry standard since the late 1970s because of their convenient mathematical properties. NURBS enable

interactive and smooth free-form surface modeling for organic shape design and they are suitable to exactly represent circles and ellipses, which are important shape primitives used in CAD. Today, many efficient and stable numerical algorithms exist to construct CAD objects using NURBS. However, the representation of NURBS objects is limited by the underlying rectangular parameter domain, which makes it impossible to model surfaces with arbitrary topology. Therefore, in practice complex objects are modeled by concatenating several NURBS patches.

Some drawbacks of NURBS are that in practice it is generally impossible to construct physically tight boundaries between different NURBS patches. The reason is that due to the non-uniform alignment of the NURBS nodes and the different degrees of NURBS used to construct adjacent surface patches, the curves that have to be merged to create an overlapping boundary at the intersection between two surfaces are not equal. An extension of NURBS, called “T-splines,” partially solves this issue.

Another drawback of NURBS is that they are not locally refinable in the sense that a local increase in resolution of a NURBS surface patch can only be achieved by increasing the overall global resolution of the patch, thereby adding a global excess of parameters without practical need. This implies that in the process of shape modeling, when a user needs to add more flexibility to a region by increasing the number of control points, this is only possible by globally adding control points. This results in an excess of parameters and increases the complexity of the model where it is not required. Furthermore, the interactive manipulation of NURBS objects is not intuitive because the parameters called “control points,” that a user can displace with a device such as a computer-mouse, do not lie on the object itself.

Also, there are weights in the NURBS formulation that have no physical interpretation and are non-intuitive to handle. In interactive shape modeling they are typically hidden to the user, who only interacts with the control points.

A fundamental limitation of NURBS and T-splines, is that they are not interpolatory except for the degree 0 and 1, which corresponds to a non-smooth polygon-based model. This is a problem when dealing with complicated, possibly twisted, organic surfaces because the control points do not lie on the surface of the object and hence, might cause non-intuitive behavior.

Furthermore, NURBS and T-splines only allow coupled control of geometrical quantities that depend on higher order derivatives of an object such as tangent planes or curvature. Therefore, in NURBS and T-spline modeling, the user can only control a shape by changing the vertices of the control polygon. Because these vertices do not interpolate the shape, the more control points are used, the more difficult it becomes for the user to associate a control point with the corresponding region of the surface that is affected.

To perform FEA on a CAD model, which is typically represented using NURBS, the representation of the geometry needs to be converted into a mesh, which includes triangles or quadrilaterals to represent surfaces or hexahedra and tetrahedral to represent volumes. These building blocks of a mesh are the “finite elements” that are used to represent an ASG in FEA.

The process of mesh generation is fundamental in FEA and arguably the most-delicate and time-consuming step in CAD-based CAE. The final mesh needs to fulfill several important criteria regarding its structure, level of detail, size of elements and overall mesh quality, for example to ensure that a surface or volume does not contain any holes, and that the smoothness of curves, edges or corners corresponds to the desired accuracy. Studies show that in the aerospace, automotive and naval industry the process of mesh generation takes approximately 80% of the overall time devoted to create an ASG from a CAD model to be used in FEA. See for example “Isogeometric Analysis: Toward Integration of CAD and FEA,” Cottrell, Hughes, Bazilevs, 2009, John Wiley & Sons Ltd. Also, subsequent design iterations are usually required in a manufacturing process while prototyping and developing, which entail additional necessary and cumbersome adjustments to the ASG.

The extension of NURBS to T-splines has introduced several simplifications to the FEA process because it allows to alleviate some of the issues involved in FEA mesh generation which are related to the generation of exact boundaries between NURBS surface patches. However, the fundamental CAD-related limitations of T-splines, which originate from the fact that the building blocks of T-spline are NURBS, still remain. The process of solving an FEA problem using NURBS or T-splines is typically referred to as IGA, however, it is also possible to perform IGA using other mathematical functions.

Accordingly, in light of the above described deficiencies in methods and systems for modeling, generating, modifying, and representing CAD objects and creating ASGs and their geometries, advanced technologies and methods are desired, to further improve the compatibility between CAD and FEA or IGA design, representation, manipulation, and modification of CAD objects, and subsequent mesh generation to create an ASG. More precisely, it is desirable to deploy H-spline-based CAD to create ASGs in an FEA or IGA context.

### SUMMARY

In accordance to one aspect of the present invention, a method for performing H-spline compatible isogeometric analysis (IGA) on a geometric object is provided, the method being performed on a computer device having a memory. Preferably, the method includes the steps of creating an analysis suitable geometry (ASG) using H-splines from the geometric object, the geometric object being represented by H-splines, storing the analysis suitable geometry (ASG) in the memory; and performing the H-spline compatible IGA on the ASG stored in the memory of the computer device to generate the data the represents a stiffness matrix and a force vector of the H-spline compatible IGA.

In accordance with another aspect of the present invention, a system for performing H-spline compatible isogeometric analysis (IGA) on a geometric object is provided, the system including a computer device having a memory. Preferably, the computer device configured to create an analysis suitable geometry (ASG) using H-splines from the geometric object, the geometric object being represented by H-splines, store the analysis suitable geometry (ASG) in the memory of the computer device, and perform the H-spline compatible IGA on the ASG stored in the memory of the computer device to generate the data the represents a stiffness matrix and a force vector of the H-spline compatible IGA.

In accordance with yet another aspect of the present invention, a non-transitory computer-readable medium having computer code recorded thereon is provided, the computer code configured to perform a method for performing H-spline compatible isogeometric analysis (IGA) on a geometric object when the computer code is executed on a hardware computer having a memory. The method preferably includes the steps of creating an analysis suitable geometry (ASG) using H-splines from the geometric object, the geometric object being represented by H-splines, storing the analysis suitable geometry (ASG) in the memory; and performing the H-spline compatible IGA on the ASG stored in the memory of the computer device to generate the data the represents a stiffness matrix and a force vector of the H-spline compatible IGA.

Moreover, according to another aspect, a computer system having a hardware processor, a display, memory, and possibly a graphics processing unit (GPU) is provided, the hardware processor configured to create an ASG representation from a CAD model based on H-splines, which includes the creation of a curve, surface or solid volume using H-splines and its digital mesh representation possibly rendered by the GPU and displayed by the display unit and possibly temporarily stored on a computer-readable storage medium. This step involves the creation of H-spline based ASG data in memory or on a computer-readable storage medium, which includes the encoding of the specific H-spline function used, the coordinates of control points, the refinement factor, the sampling rate for displaying and rendering purposes as well as the necessary hardware.

According to another aspect of the present invention, a computer system having a hardware processor and possibly a GPU and memory is provided, a processing unit such as a hardware processor or GPU configured to perform a mathematical processing method for digitally computing and representing the solution of a finite element analysis (FEA) in a mathematical functional basis, called cardinal B-spline basis, which is included in the functional space generated by the H-splines used to create the ASG.

According to yet another aspect of the present invention, a computer system having a hardware and possibly a GPU and memory is provided, the hardware processor or GPU configured to perform a digital and lossless change of basis of the FEA solution, which is initially digitally represented in a B-spline basis and then converted into an H-spline basis in a geometrically and mathematically exact manner through a hardware processor configured as a data transformation unit.

According to still another aspect of the present invention, a non-transitory computer readable medium having computer instructions recorded thereon is provided, the computer instructions configured to perform a method when executed on a hardware processor of a computer having memory and a display. A method for creating a digital pipeline for H-spline based finite element analysis (FEA) on a hardware processor and possibly a GPU is provided, hereafter referred to as H-spline based isogeometric analysis (IGA), the method being performed on a computer device having a display and memory. Preferably, the method comprising the steps of computing and matching the refinement level of the digital IGA representation to the refinement of the digital CAD model while potentially displaying the CAD model on a display unit possibly rendered on a GPU.

The above and other objects, features, and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

FIG. 1 depicts a schematic exemplary flowchart for a method 500 of performing an isogeometric analysis (IGA) or finite element analysis using H-splines in a computing environment, according to one aspect of the present invention;

FIG. 2 depicts a schematic exemplary flowchart for a method 1500 of manufacturing and production, that integrates the H-spline based isogeometric analysis (IGA) method 500 shown in FIG. 1, according to another aspect of the present invention;

FIG. 3 depicts a schematic exemplary representation of substep S110 of the IGA computation step S100 of method 500 that converts a connectivity array CA that represents the H-spline based CAD data into an H-spline patch-based parameterized surface PPS;

FIG. 4 depicts a schematic exemplary representation of substep S120 of the IGA computation step S100 of method 500 that implements the H-spline based IGA equation solver;

FIGS. 5A and 5B depict schematic exemplary representations of the substeps S132 and S134, respectively, of performing a digital conversion, with substep S132 where a stiffness matrix K is input and split into the quantities K1, . . . , Kk such that each Ki is processed in parallel by k digital converters (FIG. 5A), and with substep S134 where a force vector F is input and split into the quantities F1, . . . , Fk such that each Fi is processed in parallel by k digital converters;

FIG. 6 depicts a schematic exemplary representation of substep S140 that is part of the IGA computation step S100 of method 500 implementing an adaptive refinement unit;

FIG. 7 shows a schematic, perspective view of a computer system CS or a plurality of devices that can be used for implementing the method 500 of performing an isogeometric analysis or finite element analysis using H-splines, according to another aspect of the present invention; and

FIG. 8 shows a schematic view of the processing device of an exemplary method, according to still another aspect of the present invention.

Herein, identical reference numerals are used, where possible, to designate identical elements that are common to the figures. Also, the images may be simplified for illustration purposes and may not be depicted to scale.

### DETAILED DESCRIPTION OF THE SEVERAL EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

According to some aspects of the present invention, a system, a method, and a non-transitory computer readable medium having a software recorded thereon are provided that allow strongly extending and improving upon FEA and IGA. One limitation of the currently existing FEA methods is the mathematically functional incompatibility between the representation of an FEA solution and its related CAD model, conventionally used in many commercially available CAD software. This incompatibility is at the origin of a time-consuming and cumbersome mesh conversion procedure that needs to be carried out to convert a NURBS CAD model into a mesh, which includes triangles or quads, or tetrahedra and hexahedra, or other types of meshes. The FEA solution is then applicable to the mesh and not directly to the original CAD geometry, which also results in a loss of precision. Furthermore, if based on the FEA simulation, the CAD model must be changed, it can take as much time to transfer back FEA data to the CAD model as the for the mesh conversion process, because the FEA and CAD model are inherently incompatible. The negative consequences in applications are an inaccurate approximation of the CAD model by the mesh, the need to improve the mesh quality to run the simulation, and the incompatibility to transfer data from the mesh back to the CAD model. Due to the above-mentioned existing limitations, FEA-based CAE remains a costly, challenging, and time-consuming task. The results are rapidly increasing costs for manufacturing companies due to investment in an expensive CAD/CAE/CAM infrastructure.

NURBS, T-splines, and H-splines

A partial alleviation to this problem has been presented by IGA using T-splines, which allows for a direct representation of an FEA solution in the functional space spanned by T-splines, which are an extension of NURBS. However, NURBS and T-splines have geometrical limitations which render the CAD process difficult.

One limitation of NURBS and T-spline surfaces is that they cannot be interpolatory and smooth, i.e., C¹, at the same time. Thus, interpolatory NURBS models are constructed through linear interpolation between the control points and the resulting surface correspond to polygon meshes which have a lot of discontinuities such as non-smooth edges and kinks. H-splines allow to construct interpolatory surfaces that are at least in C¹ or possibly have smoothness properties of arbitrary high order. This means that they are smooth which allows organic shape design and the control points are directly lying on the surface.

Another limitation of NURBS surfaces that has been solved by the invention of T-splines is that NURBS do not allow to locally refine surfaces. A refinement is generally characterized by increasing the number of parameters without changing the geometry of the surface object. With T-splines, this is done by introducing T-junctions into the control mesh of a surface. NURBS only allow for a global refinement which results in an excess of unused parameters in the case where only a local refinement is needed. In the case of NURBS, a refinement of one region in the control mesh must necessarily result in a refinement of the entire control mesh. However, the T-spline solution for local refinement has a drawback as it requires the introduction of new local coordinate systems for each region that must be refined. These local coordinates are independent of the global parameterization and introduce a certain parameterization-incompatibility. The formulation is algorithmic and becomes complicated if a lot of T-junctions need to be inserted in a mesh.

In the publications of Sederberg, see Sederberg et al., “T-splines and T-NURCCs,” ACM Transactions on Graphics, Vol. 22, Issue 3, July 2003, pp. 477-478, and Sederberg et al., “T-spline Simplification and Local Refinement,” ACM Transactions on Graphics, Vol. 23, Issue 3, August 2004, pp. 276-283, these publications herewith incorporated by reference in their entirety, a generalized formulation of NURBS called “T-splines” has been presented. They allow to construct T-structures in the parameter domain by inserting T-junctions. Based on T-splines an algorithm was proposed to mathematically tighten the intersections between NURBS surfaces that have the same degree. Sederberg published a method for local refinement of T-splines to add local flexibility to NURBS. Due to the tensor-product structure of NURBS, up to now, refining one basis function entailed that an entire row or column of nodes in the rectangular parametric domain had to be added. Hence, only global refinements were possible. The algorithm of Sederberg presented a way to construct detailed NURBS surfaces without the need of an excess of degrees of freedom. The existing T-spline technology only allows connecting surface patches by joining two boundaries of the control mesh. With the invention of H-spline, for the first time a solution has been proposed to connect arbitrary regions of two or several control meshes with each other.

With H-splines, a local refinement in one or both directions of the control mesh is possible without changing the geometry of the surface. The operation is mathematically in-line with the global parameterization. The provision of H-splines to construct watertight surfaces dramatically alleviates the drawbacks of NURBS and T-spline-based CAD modeling. The T-splines are discussed in U.S. Pat. Pub. No. 2017/0357736, this reference herewith incorporated by reference in its entirety. H-splines allow direct control of smooth surfaces or volumes, and also provide augmented access to a geometrical object, which can then be deployed in an interactive CAD environment to decouple the direct control of tangents, curvature, and other geometrical quantities. H-splines allow for local refinement of an object and all the H-spline parameters typically directly lie on the CAD object itself resulting in more intuitive shape manipulation and shape modeling. Moreover, a more localized control of the CAD object is possible with H-splines compared to NURBS or T-splines.

Another limitation of T-splines and NURBS is that they do not allow the direct control of quantities from differential geometry, which depend on higher order derivatives such as controlling tangents, tangent planes, and curvature. H-splines do not only interpolate the surface itself but also its higher order derivatives and cross-derivatives. Furthermore, T-splines and NURBS allow to directly control these quantities in a decoupled manner, meaning that they can be modified independently from each other. This allows to directly control the tangent planes or the curvature of a curve along one parameter direction. This feature allows for new possibilities in shape modeling because by modifying the tangent plane, the surface is locally modified without changing the location of the interpolating control point. This opens new possibilities in shape modeling. Furthermore, H-splines allow for a more localized control when displacing a control point than NURBS or T-splines because their support is minimal and considerably smaller.

Because NURBS and T-splines are polynomial, non-polynomial shapes such as conic sections only can be represented with rational expressions, which allow to represent, for instance, an arc of a circle. Then, several arcs are combined to represent a full circle. The generalized H-splines are not restricted to polynomials but can also represent exponential polynomials. This allows to exactly construct trigonometric, hyperbolic, and polynomial shapes or a combination of them. Thereby, no segments have to be patched together and fewer control points are needed than with NURBS or T-splines. Furthermore, transcendental shapes such as helices or spirals, which cannot be represented with NURBS are easily constructed with H-splines.

T-splines extend NURBS such that it becomes possible to connect two surface patches in a watertight manner, as discussed in U.S. Pat. Pub. No. 2017/0357736, this reference incorporated by reference in its entirety. However, this only allows to connect surface patches through the boundaries of their control meshes. H-splines provide a simpler and technically more efficient way to create such physically leak-proof junctions because the control points do not only interpolate the CAD object but also the parameter domain; an essential simplification in the construction of physically watertight junctions.

H-spline Functions

A continuous one-dimensional function is represented using H-splines, for t ∈ [symbol] and k ∈ [symbol] it is defined as Φₖ(t) as

f(t)=ΣₖcₖΦₖ(t), Eq. (1)

where the coefficients cₖ ∈ [symbol] coincide with samples of the function f as well as samples of its derivatives up to any given order. The sum in equation (1) is finite. This spline can then further be used to construct H-spline surfaces as defined below in Equation (3).

H-Spline Refinement and Subdivision

Next, the H-spline refinement is explained. With this processing step, more control points are generated on a surface without changing the geometry of the shape. This allows one to perform local and global surface refinements. The property that enables this processing step originates from the refinability property of the H-splines. For a positive integer m the refinement relation is specified by

Φₖ(t)=ΣᵢHᵢΦ_{k,i}(mt), Eq. (2)

where Hᵢ are suitable coefficients such that Equation (2) holds.

Equation (2) describes how one H-spline can be described as a sum of several refined H-splines. This step allows to replace one control point by several new control points without changing the surface geometry in a shape modeling setting.

H-spline Surfaces

A parametric surface σ=(x, y, z) using H-splines is given by:

σ(u, v)=(x(u, v), y(u, v), z(u, v))=Σ_{k,l}c_{k,l}Φₖ(u)Φₗ(v), Eq. (3)

where c_{k,l} ∈ [symbol] ³ coincide with points of the surface and its derivatives and possibly higher order derivatives.

An elementary local refinement operation is achieved by refining one control point of σ with the coordinates (p, q) for p, q ∈ [symbol] with respect to one direction of the parameter domain. By performing a refinement operation on one control point, in the parameter domain the corresponding vertex is replaced by several new H-junctions. This operation does not change the geometry of the surface. The refinement of a point c_{p,q} is expressed as

σ(u, v)=Σ_{k,l}c_{k,l}Φₖ(u)Φₗ(v)= [symbol] [symbol] c_{k,l}Φₖ(u)Φₗ(v)+Φₚ(u) [symbol] c_{p,l}Φₗ(v)+Φₚ(u)c_{p,q}ΣᵢHᵢΦ_{q,i}(mv). Eq. (4)

The refinement of the surface point c_{p,q} will lead to new interpolating surface points as well as to points that interpolate their corresponding higher-order derivatives. A local refinement operation can also be applied to several neighboring control points or even an entire row or column in the parameter domain. Moreover, H-splines allow for performing a direct surface control of the displayed graphical elements such as higher order derivatives. If we define

$${σ}^{( i , j )} ( k , l ) = {σ}^{( i , j )} ( u , v ) {\vert}_{u = k , v = l} = \frac{{\partial }^{i + j} σ ( u , v )}{{\partial }^{i} u {\partial }^{j} v} {\vert}_{u = k , v = l} , \qquad Eq . ( 5 )$$

then, the surface formulation using H-splines implies that if the control points σ^{(0,0)}(k,l), which interpolate the surface are displaced, the surface immediately changes. Similarly, the control of higher order quantities that are related to the surface can directly be controlled. For example modification of the points σ^{(1,0)}(k,l) and σ^{(0,1)}(k,l)) allow to control the tangents along the u- and v-direction at the surface point σ(k,l). Higher order cross-derivatives are modified by changing the locations of σ^{(2,1)}(k, l), σ^{(1,2)}(k,l), and σ^{(2,2)}(k,l) for instance.

Watertight Junctions Using H-Splines

It is possible to create watertight junctions between H-spline surfaces. With the use of H-splines it is possible to exactly represent any curve segment on a surface corresponding to a straight line segment in the parameter domain between any two given control points (which lie on a parameter line) as a possibly refined H-spline curve f(t)=(fₓ(t), f_{y}(t), f_{z}(t)). Thereby, no additional control point is used to construct f than the ones that lie in between the given control points.

In the most general case the curve segment f₁ of a surface σ₁ is to be replaced by f₂ of a surface σ₂. The curve segment f₂ needs to be expressed with only the (possibly) refined control points that describe this curve itself.

H-spline Solids and Volumes

All the operations and representations using H-splines mentioned above can directly and easily be extended to create solids or volumes and to perform the related computations, such as refinement or the creation of watertight junctions, on these objects. Thereby, the bivariate tensor-product structure is extended to the volumetric trivariate spline structure in a similar manner as it is done to represent volumes and solids in the case of NURBS or T-splines.

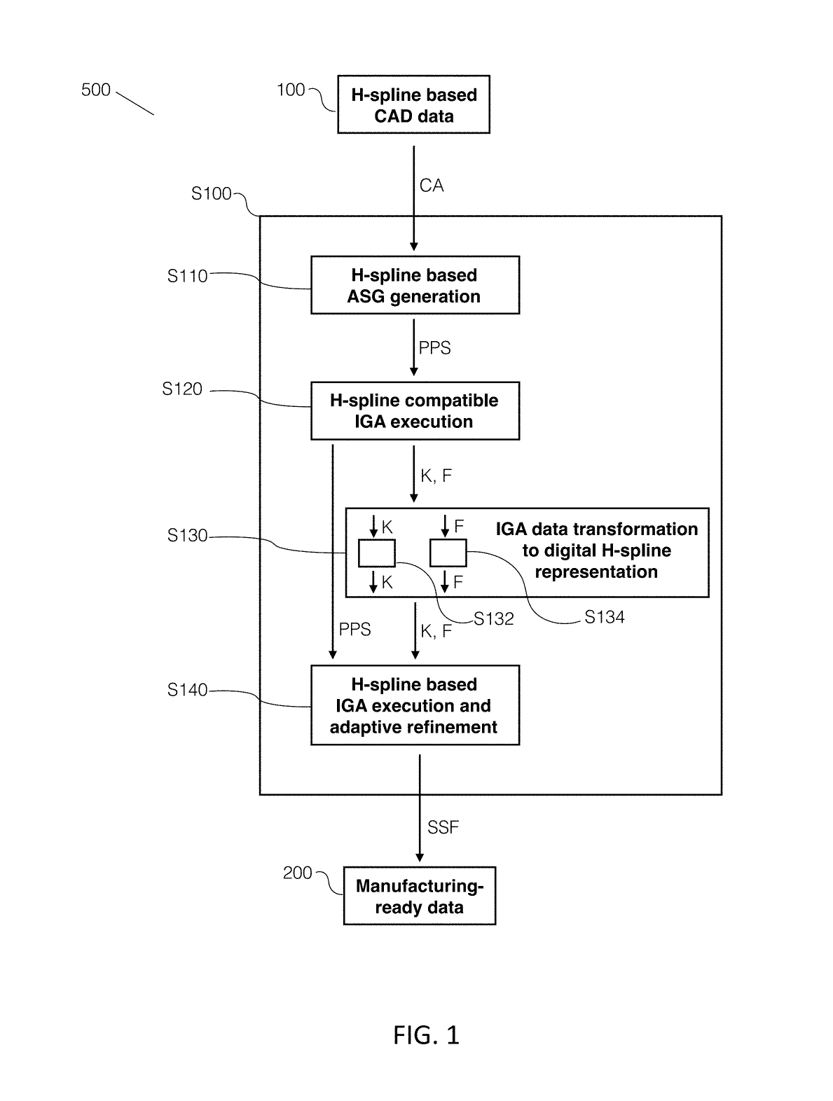

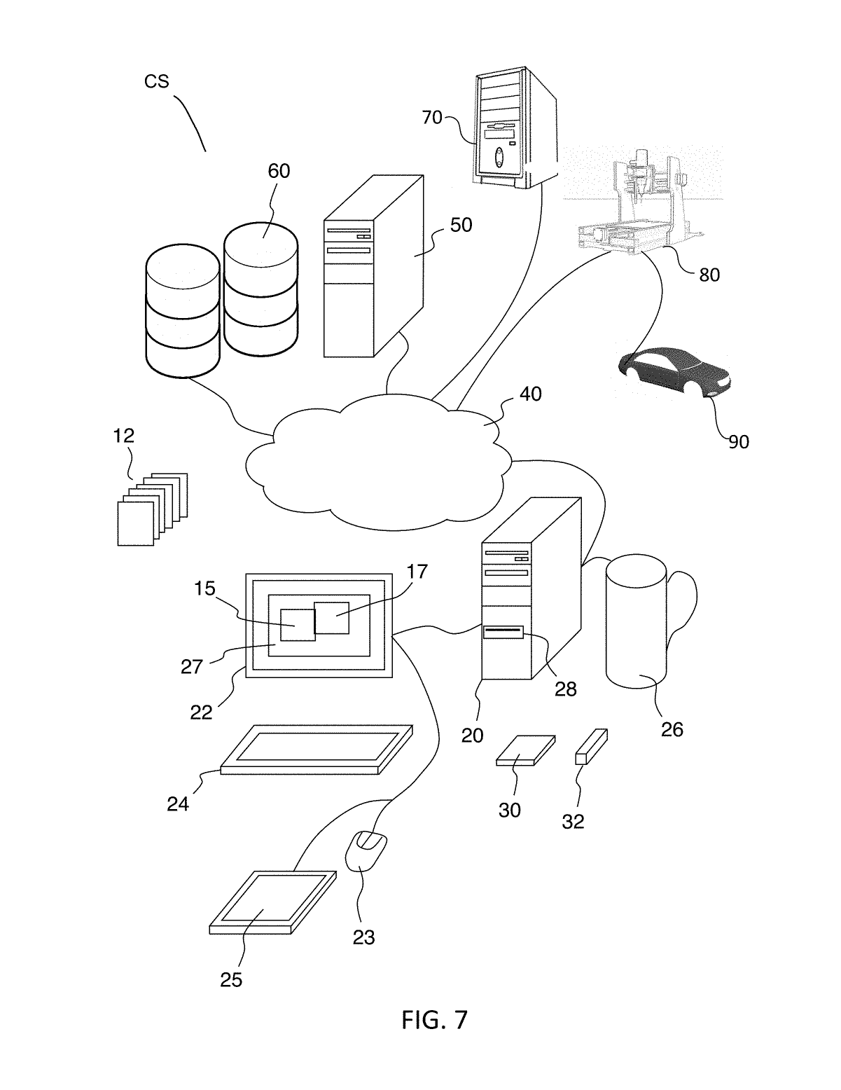

In FIG. 1, an exemplary simplified flowchart is shown for the method 500 of performing an IGA or finite element analysis using H-splines with a computing system, for example system CS shown in FIG. 7. An existing H-spline based CAD object might have been modeled in any existing CAD software prior to carrying out the IGA and possibly stored in any CAD-related format and possibly reloaded by a CAD software. Also, an initially non-H-spline based CAD model might be converted into an H-spline based CAD model to represent the H-spline based CAD data of method 500. An example of an existing CAD model can be but is not limited to a part that needs to be manufactured or modified, for example a chassis of a car, a wing or carcass of an aircraft, a mechanical part such as a break disk, a wheel, a turbine, a propeller or a carcass of a boat. It might have been initially modeled using H-splines and saved and reloaded in any kind of CAD format such as 3DM, 3DS, DWG, DXF, FBX, IGES, CML, LWO, OBJ, PLY, Points, SLC, SKP, STEP, STL, VRML, AMF or other formats, or it might have been modeled using NURBS, polygons or any other modeling method and later converted into an H-spline based model and then further processed as H-spline based CAD data in method 500.

Regardless, which possible method mentioned above to generate H-spline based CAD data is used, a step 100 is performed in which a connectivity array CA is generated from the CAD object data. This CA represents and includes all the information to describe an H-spline based CAD model. Next, the connectivity array CA is input to a step S100 of the method 500 that performs the IGA computation. This step S100 has several substeps. First, in a substep S110, an H-spline based analysis-suitable geometry (ASG) is computed from the CAD data represented as a connectivity array CA. The ASG is represented as a patch-based parameterized surface (PPS) that is output from this step. A second substep S120 is then performed on the PPS, and solves the IGA on the ASG using cardinal B-spline filters. In this step, the PPS is required to define the shape where the IGA should be performed on. The PPS itself remains unchanged during this step. The substep S120 outputs a stiffness matrix K and a force vector F, which is then input into a next substep S130 that converts, in a lossless manner, the generated IGA data, stiffness matrix K and force vector F, represented with B-splines into an equivalent H-spline representation. This process is executed in parallel for stiffness matrix K by a substep S132 that is part of step S130 and for force vector F by a substep S134 that is also part of step S130.

Next, a substep S140 receives data from PPS, K, and F, in the H-spline representation, and computes adaptive refinement of K and F, thereby iteratively refining the IGA solution and the ASG with an equivalent refinement step, to calculate a solution surface (SSF). The SSF data is output, which can also describe a volume enclosed by a surface because any volume can be described by the surface that encloses it. The SSF can then be input into a step 200 where the manufacturing-ready data is generated by a data processing device, that is suitable to manufacture the CAD object. Next, manufacturing-ready data can be transmitted, sent or otherwise provided to via a network 40 to an automated manufacturing device 80, to manufacture or modify a component 90, as exemplarily shown in FIG. 7.

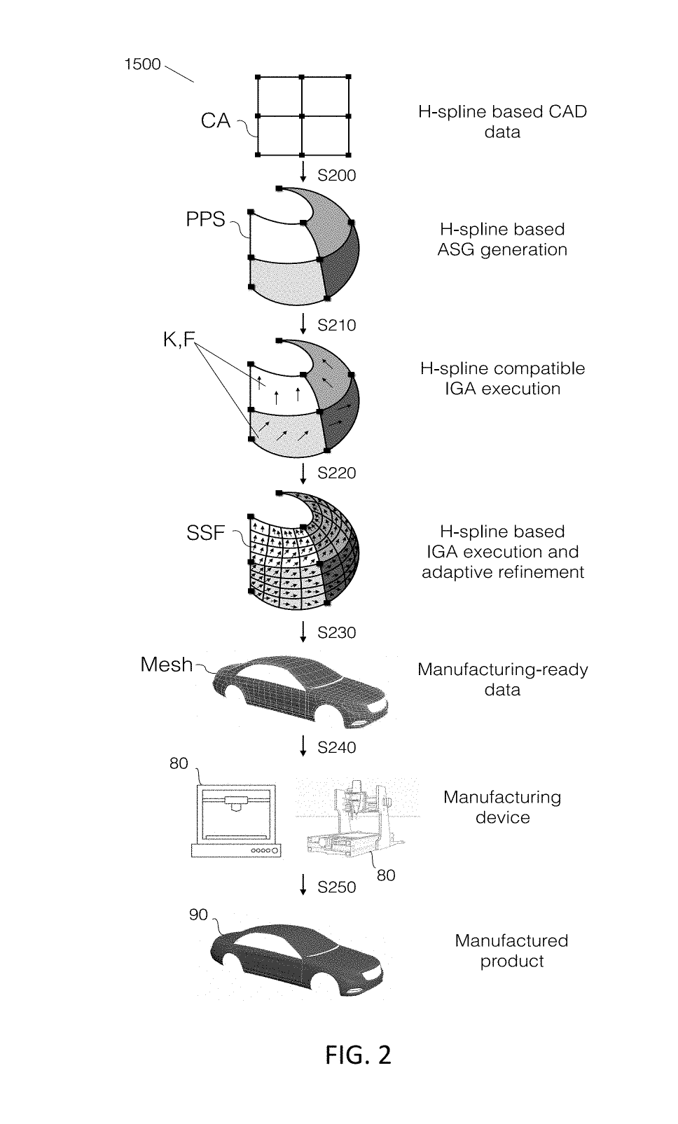

FIG. 2 shows a schematic representation of an exemplary manufacturing and production method 1500, that integrates the H-spline based IGA method 500. In a first step S200, from the H-spline based CAD data that is represented as a connectivity array CA, an H-spline based analysis suitable geometry (ASG) is generated, which is represented as a patch-based parameterized surface PPS. This step corresponds to steps 100 and S110 of FIG. 1. Next, in a step S210, an H-spline compatible IGA is executed to analyze and simulate physical properties of the PPS, for example but not limited to aerodynamic characteristics, strength-related characteristics, physical resistance to mechanical forces due to stress, weight, temperature, or loads. In such a context, the surface that is originally described by a CAD model and which describes a device 90 that is to be manufactured or modified is represented as a PPS to be suitable for IGA. For example, device 90 could be an automotive part, for example a chassis of a car as exemplarily shown in FIG. 2.

In a first step a CAD model is designed, before having analyzed or simulated any physical properties of the CAD model. Then the CAD model that is converted to a PPS, which allows to simulate physical properties, for example aerodynamic properties of the chassis and its material related to different speeds and wind conditions. Aerodynamic forces, frictions and deformations are simulated for every single point on the PPS, which allows to measure stress and force resistance as well as possible damage caused under certain physical conditions. All these physical properties are described by mathematical equations computed in a step S210 that involves the calculation of a stiffness matrix K and a force vector F, which describe the physical properties of the PPS. In FIG. 2, these properties are shown as arrows for representation purposes. Also, step S210 corresponds to substep S120 and S130 of FIG. 1. In a further step S220, adaptive refinement of the IGA is carried out to improve the accuracy of the computation and simulation of the physical properties. This step also increases the resolution of the ASG and hence, of the PPS. This leads to a more precise solution of the IGA, to obtain a more refined SSF.

Then, in a step S230, the solution surface SSF can be converted into a mesh that serves as manufacturing-ready data for a real object, for example but not limited to an automotive part, machine part, etc. The manufacturing-ready data can be computed to be in a pre-defined manufacturing file format, such as but not limited to 3DM, 3DS, DWG, DXF, FBX, IGES, CML, LWO, OBJ, PLY, Points, SLC, SKP, STEP, STL, VRML, AMF and other formats, and can be directly input into a manufacturing device 80 such as but not limited to an automated manufacturing apparatus, device, or system, for example but not limited to a computerized numerical control (CNC) machine, mill, lathe, plasma cutter, electric discharge machine (EDM), water jet cutter, multi-spindle machine, 3D printer, bending and stamping machine, in a step S240. Also, the manufacturing-ready data can be input to a commercial CAD/CAE/CAM software and further modified. Thereafter, in a step S250, based on the manufacturing-ready data and the manufacturing device, a manufactured device 90 is made, manufactured, or modified as a resulting product of manufacturing and production method 1500.

ASG Creation from H-spline CAD Model

As explained above with respect to FIG. 1, an analysis suitable geometry (ASG) is extracted from an existing CAD object defined as an H-spline surface or volume by substep S100 of method 500. With this substep S100, the complete geometry of the CAD object is entirely defined by the discrete set of the H-spline control points. They allow for further digital refinement in the IGA process without changing the geometry.

A second important property of an H-spline surface or volume is the fact that H-splines interpolate the geometrical object and hence, enable to establish a one-to-one correspondence with the parameter domain. This property allows for an immediate implicit boundary interpolation of the geometry without the need of applying additional constraints as is the case with models, where the control points do not interpolate the shape: Thus, the interpolation property of H-splines represent a substantial simplification compared to NURBS or T-splines based IGA. With the latter two models, special constraints regarding boundary interpolation conditions have to be established in order to perform a proper IGA.

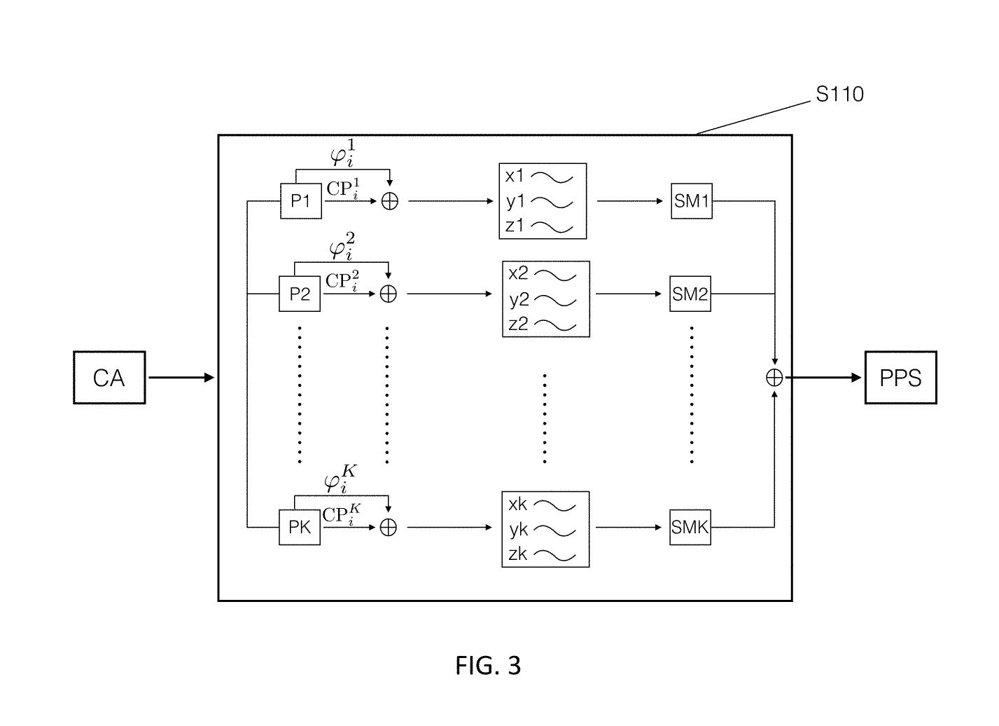

The method 500 explained above, and corresponding system CS that performs the method 500 present substantial advantages over the state of the art. A watertight H-spline surface or solid can readily be converted into a patch-based parameterized surface PPS, which includes parametric H-spline surface patches with rectangular topology. Each patch can be computationally processed individually which allows for a parallelization of the IGA process as shown in FIGS. 3. 4, 5A, and 5B.

Furthermore, in the H-spline formulation the control points and knots coincide in the parameter domain as well as on the geometric object. This property facilitates the control of patch-based IGA because the potentially shared boarders of surface patches are easily identified.

Moreover, with the features discussed herein, it is possible to provide for a data processing environment that allows to convert object data, for example CAD model data, from the pre-existing CAD, CAE, and CAM world, and other software environment for finite element analysis, into the world of H-spline, as defined in U.S. Pat. Pub. No. 2017/0357736, presenting the advantages of the easy creation of watertight boundaries between two different objects or surfaces, the direct and possibly interactive control of higher-order derivatives of shapes, and the possibility of refining of surfaces and objects to a higher mesh resolution. Conversely, object data of the H-spline environment can be readily converted back into object data, for example manufacturing ready data, of the CAD, CAE, and CAM world. With the help of parallel and fast graphics processing, this conversion from CAD model data to H-spline and back can be done in real-time, such that the object data of the CAD model and H-spline model can be visualized simultaneously on a display screen 22. This allows to preserve and using standard and established software for object modelling, simulation, and processing, whilst at the same time use the advanced features of the H-spline modelling.

FIG. 3 shows a schematic exemplary representation of the substep S110 of the IGA computation step S100 of method 500 that converts a connectivity array CA that represents the H-spline based CAD data into an H-spline patch-based parameterized surface PPS. The connectivity array CA includes all the essential information needed to describe and represent an H-spline based shape, as well the connection between neighboring control points CP, as explained in U.S. patent application Ser. No. 15/817,236, this reference herewith incorporated by reference in its entirety.

Substep S110 decodes the CA as a block-wise modular representation, each block processing one surface patch P1, . . . , Pk defined by its control points CP, and all block operations can be executed in parallel. Thereby, each surface patch represents a physical part of the original CAD model and hence, also represents a physical surface patch of the product that might be eventually manufactured.

Each block acts as a converter that reconstructs the patch-based coordinate signals x, y, z, from the corresponding samples CP, which are represented in Cartesian coordinates and act as control points as well as the H-spline functions. The reconstructed coordinated signals together x, y, z build the parameterization for each patch, for each patch forming a surface mesh SM1, . . . , SMK. The mesh lines of the SMi are given by the connectivity of the control points CPi which act as the vertices of the SMi. All the surfaces meshes SMi can be generated in parallel and unified to represent the patch-based parameterized surface PPS, which is the output of step S110;

Digital Functional H-spline-compatible IGA

In an isogeometric analysis (IGA) framework the CAD object and the IGA solution are represented in the same functional space using the same basis functions. This is the fundamental reason why no mesh-conversion between the CAD object and the FEA model is required. H-splines have the property that the functional space that they span includes the functional space spanned by (non-rational and possibly exponential) cardinal B-splines. Therefore, the IGA solution is first formulated using refinable B-splines since in the FEA context the several advantageous CAD properties of H-splines are not needed, and hence, the simpler formulation of B-splines is more convenient. In a second step the B-spline solution is lossless converted into an H-spline representation such that the functional IGA and CAD space coincide. In FEA as well as IGA the infinite dimensional solution space of a boundary value problem is approximated by a finite dimensional space. According to an aspect, herein the finite dimensional space is spanned by a set of cardinal B-splines given by [symbol] and the set of control points is [symbol] such that a function f is approximated as

f(t)=Σₖcₖ^{β}βₖ(t). Eq. (6)

Then, the stiffness matrix K and the force vector F as in traditional FEA or IGA. The stiffness matrix K and force vector F include integral-based quantities, which in traditional IGA are approximated using Gaussian quadrature rules. These quantities can, in most cases, easily be evaluated in an exact manner by exploiting the property that the integral of two shifted B-splines might be expressed as an augmented order B-spline. Also the present formulation usually allows one to avoid the need of computing derivatives of rational functions, as is the case with NURBS and T-splines.

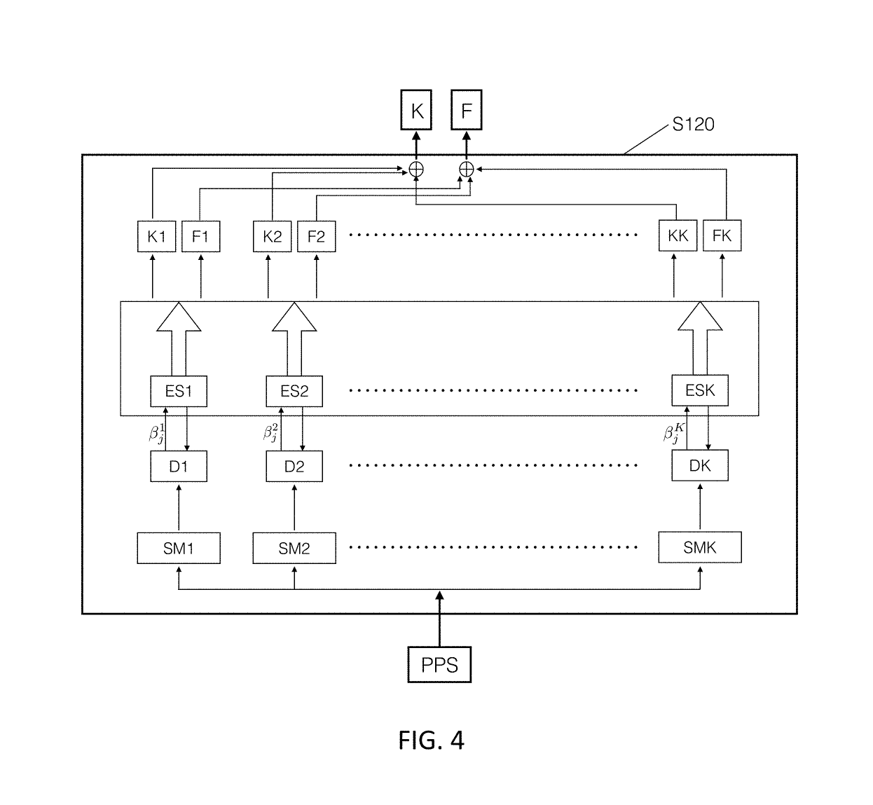

An H-spline compatible generation of an IGA using cardinal B-splines is performed on a device 20, which digitally computes the mathematical solution of the FEA or IGA problem. FIG. 4 shows a schematic exemplary view of substep S120 of the IGA computation step S100 of method 500 that implements the H-spline based IGA equation solver. A patch-based parameterized surface PPS serves as input coming from step S120. Each surface mesh SM, each constituting a subunit or partial element of the PPS, can be processed in parallel. For each SMi a domain computation unit Di communicates with an equation solver ESi. The equation solver ESi numerically evaluates the solution on the surface domain of SMi and evaluated by Di using cardinal B-spline filters by approximating the value of an integral as a finite sum. The data generated by the ESi representing the IGA solution is expressed as subparts Ki of the stiffness matrix K and subparts Fi of the force vector F, for each surface mesh SM. All the Ki and Fi are generated in parallel and combined to generate the output stiffness matrix K and force vector F.

The use of H-spline compatible cardinal B-splines allows for both the design and analysis (FEA) objects to be represented as digital signals. As a consequence the traditional incompatibility of these two approaches is completely eliminated resulting in a pivotal improvement in precision, time savings and hence, cost reduction of the CAD/CAE/CAM process.

Lossless H-spline IGA Configuration

To explicitly represent the IGA solution in the same functional space as the CAD object it is necessary to convert the B-spline representation into an H-spline representation. This is possible because the space spanned by cardinal B-splines is included in the span of the H-splines. For each B-spline there exists a conversion operator Γ such that [symbol] ⊂ [symbol] . The application of the operator Γ to a function f as described in Equation (6) yields the new control points in an H-spline basis of the function f such that the two representations reproduce exactly the same function. Hence, Γ yields a lossless change of basis of a function f.

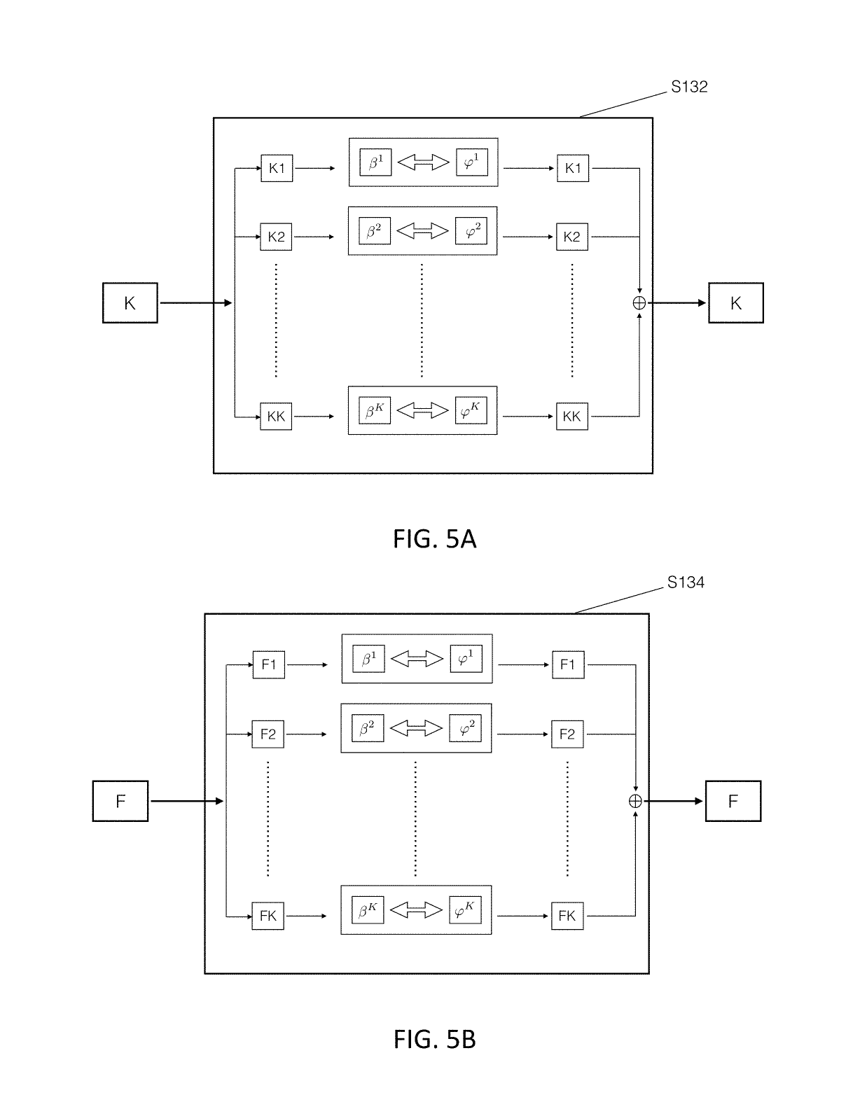

By using data processing device 20, a mathematical formulation is established which performs a lossless data transformation to convert the digital cardinal B-spline representation of the IGA or FEA solution into an H-spline based representation. FIGS. 5A and 5B show exemplary representations of substep S132 and substep S134 that act as digital converters, being part of substep S130, and in turn part of the IGA computation step S100 of method 500. Steps S132 and S134 convert the digital coefficients of the cardinal B-spline filters of the stiffness matrix K and the force vector F in parallel into digital coefficients that represent the same stiffness matrix K or force vector F using digital H-spline control points. In FIG. 5A a schematic exemplary representation of the digital converter of step S132 is shown, where K is input and split into the quantities K1, . . . , Kk such that each Ki is processed in parallel by k digital converters. Processing of the Ki in parallel results in a considerable speed up of the overall computation, which is crucial if a surface consists in many surface patches. The digital converters S132 in FIG. 5A and S134 in FIG. 5B act as digital filters in such a way that they filter the control points related to cardinal B-splines with a digital filter that converts them into control points that represent an H-spline function as described in equation (1). Therefore, each digital converter outputs the same K1, . . . , Kk, however, represented with H-spline coefficients. In FIG. 5B the same operation as in FIG. 5A is carried out by substep S134, where the input and output is the force vector F. It is then split into the quantities F1, . . . , Fk such that each Fi is processed in parallel by k digital converters to accelerate the computations. Then each digital converter outputs the same F1, . . . , Fk, however, represented with H-spline coefficients.

H-spline IGA Computation

The configuration and computation of an H-spline based IGA requires that the resolution of the FEA or IGA solution and the CAD object be the same. As described by Equation (2), the refinement factor m defines this resolution. Once the IGA and CAD solution are expressed in the same functional H-spline space, setting m to have the same value in the CAD and IGA representation carries out adaptive refinement of the solution. Because refinement does not affect the geometry of the CAD object, m can be arbitrary small, which allows to increase the precision of the FEA solution.

An H-spline based IGA execution can be performed by data processing device 20 which possibly includes adaptive refinement of the solution as well as of the ASG-based representation of the H-spline CAD model and which can be displayed in 3D by a display device 22. The computation performed by data processing device 20 possibly includes modifying or changing the resolution, refinement and possibly sampling rate of the IGA solution and the H-spline based CAD representation. Data processing device 20 executes this task by re-computing the solutions with different precision depending on the value of the refinement factor m.

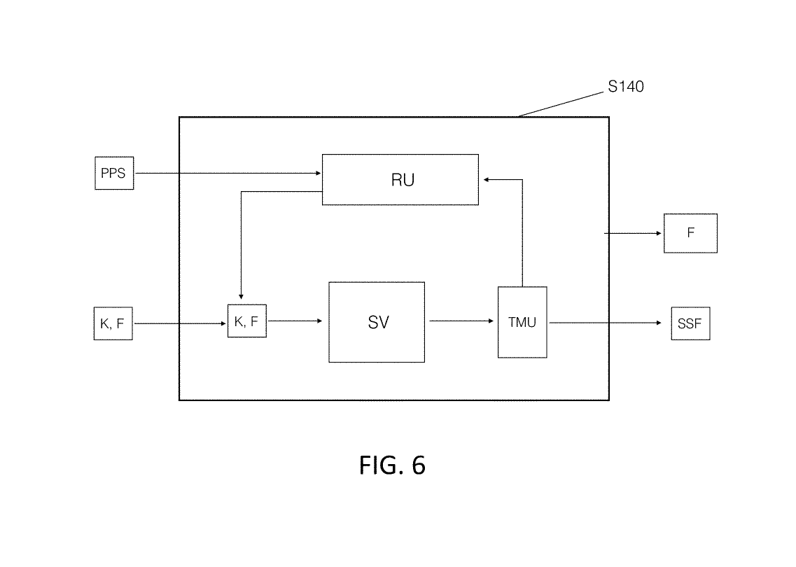

FIG. 6 shows an exemplary representation of substep S140 that is part of the IGA computation step S100 of method 500 that implements an adaptive refinement unit. It accepts a patch-based parameterized surface PPS as input as well as a stiffness matrix K and force vector F, which have been evaluated on the domain of the PPS. K and F are then input together into a solver unit SV, which numerically computes the IGA solution. The subsequently generated data is sent to a tolerance-measure unit TMU that evaluates an approximation error, which for example is computed based on the difference between the solutions obtained with two subsequent resolutions or which is based on physical criteria such as for example, but not limited to, the spatial resolution that can be described with the current refinement level or any other physically-based criterion such as temperature, weight, pressure, velocities or acceleration, electric current, magnetic fields, stress-related quantities, etc. Based on a thresholding operation the TMU outputs the solution or sends it into the refinement unit RU that refines the H-spline based representations of K and F and adapts the refinement to the H-spline based PPS. The refined K and F are then again sent to the SV and TMU for thresholding. This loop is executed iteratively until a tolerance value is reached, typically until the solution after a new refinement step does no longer significantly change from one iteration to another or if a certain number of iterations has been reached. Then the solution surface SSF is output to step S200 of method 500, for example steps of method 1500 for providing manufacture ready data in a step S240, for data processing by commercial CAD/CAE/CAM software, and in a later stage a manufactured product 90 in step S250 by a manufacturing device 80.

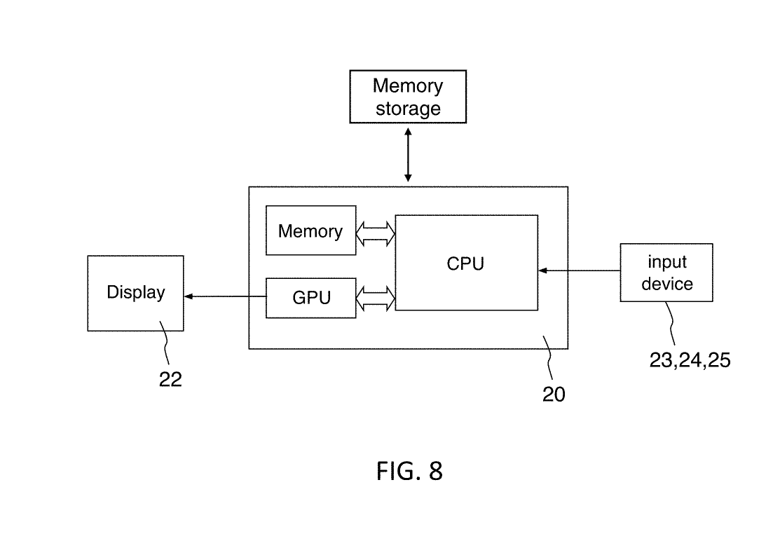

As exemplarily shown in FIG. 7, methods 500, 1500 can be performed on a computing system CS. For example, system CS can include a data processing device 20 that is operatively connected to input devices such as but not limited to a mouse 23, keyboard 24, trackpad 25, and a touch screen interface of display 22, for example a computer screen, to provide for user instructions for the methods 500, 1000. Data processing device 20 can be a computing device for example but not limited to a personal computer (PC), Macintosh™ computer, laptop, notebook, netbook, data processing workstation, smartphone, or a tablet. Data processing device 20 can include one or more hardware processors, for example one or more central processing units (CPU), one or more graphics processing units (GPU), and memory, as shown with additional detail in FIG. 8. Preferably, in a first step, an H-spline based CAD model, possibly but not necessarily having been stored on a memory storage device, is defined as input to data processing device 20, which generates an ASG using H-splines. The user can control and specify the ASG with an input device such as 22, 23, 24, 25, to generate a graphical element computed with data processing device 20 and shown in display 22.

The specification of the H-spline based ASG is executed by specification of the digital geometry representation 15, 17 through user interaction for example by 23 or 25. For example, this can be done by dragging and displacing H-spline related parameters, such as control points or sampling rate with input device 23, 25 and by global or local refinement computed through data processing device 20, or automatically or user-defined, such as by specifying mesh parameter values with keyboard 24, and then displaying the interactively defined or modified or semi-automatically or automatically generated ASG on display 22 while performing interaction with an input device 23, 25. Also, the interpolatory control points and control points that interpolate higher order derivatives that are associated with the parameterization of the ASG models 15, 17 etc. can also be represented on computer screen 22.

Moreover, system CS can further include a computing device 70 that is operatively connected to network 40, operating a commercial CAD, CAE or CAM software, for example but not limited to AutoCAD™, SolidWorks™, CATIA™, for preparing, creating and modifying a CAD data of a digital object, for example CAD data of a device 90 that is to be manufactured, modified, or processed. In addition, an automated manufacturing apparatus 80 can also be operatively connected to the network 40, to manufacture, modify, or process a physical part based on the CAD data of the digital object, for example but not limited to a CNC milling machine, 3D printer to produce a device 90, for example a component, manufactured part, finished product.

Moreover, a dataset 12 is schematically shown, that can be located locally in a storage 26 associated with data processing device 20, or can be accessed via the network 40, for example the Internet, from various remotely located devices, for example servers 50 and storage 60, for example a server of a company that provides for CAD object data. This allows to access various cloud-based and network-based services, for example but not limited to cloud or network servers 50, cloud or network data storage devices 60, specific web servers providing databases of graphics data. Display device 22 can display different stages and results of the data processing steps of the method 500, 1500, and is also capable of displaying 2D or 3D images to represent results and processing steps of the method. For example, the graphical user interface 27 can be shown, that is displaying the H-spline based ASG generated based on an H-spline based CAD model, and the shapes and appearance of possible ASG models 15, 17 can be changed directly and in real-time via the data input devices 23, 24, 25. This allows performing the direct surface control described above using H-splines.

Operation software of method 500 can be configured such that data input devices 22-25 can also be used directly control the control points of the H-spline based ASG 15 and 17 and its higher order derivatives via CPU. The modified surfaces are computed in terms of rendering primitives, which are processed in real time by a GPU to construct the graphics object and displayed by a display device 22. External memory, main memory (RAM) and graphics memory (VRAM) allow one for real time shape interaction through a display refresh rate of typically 60 Hz or more for display device 22, such as but not limited to liquid crystal device (LCD) or light emitting diode (LED) monitors, based on frame buffer updates of the graphics objects that describe the surfaces 15 and 17.

Data processing device 20 can be equipped with a data input/output port, for example a CDROM drive, Universal Serial Bus (USB), memory card readers, storage device readers, to read data, for example computer readable and executable instructions, from non-transitory computer-readable media 30, 32. Non-transitory computer-readable media 30, 32 are storage devices, for example but not limited to external hard drives, flash drives, memory cards, USB memory sticks, CDROM, Blu-Ray™ disks, optical storage devices and other types of portable memory devices that are capable of temporarily or permanently storing computer-readable instructions thereon. The computer-readable instructions can be configured to perform the method 500, as described above, when loaded to data processing device 20 and executed on a data processor of data processing device 20 or a cloud or other type of network server 50, for example the one shown in FIG. 7.

According to some aspects of the invention, method 500, 1500 and corresponding system CS can substantially facilitate the modeling process in CAD, computer-aided engineering (CAE), and computer-aided manufacturing (CAM) in the fields of mechanical modeling, industrial design, digital fabrication and manufacturing, as well as computational fluid dynamics and related fields and also animation and character design. Examples of areas of application can also be found in the automotive, naval, and aerospace industry, product design, architectural modeling as well as the design of games and animated movies. Substantial advantages are provided by the more efficient description of ASG through H-splines, enabling faster and simpler design of possibly complex watertight surfaces which can also be exploited for rapid execution of computational optimization schemes such as in any kind of mechanical modeling processes, aero- and aquadynamics, fast surface deformation processes as used in simulation and animation or the exchange and communication of protocols describing high quality surfaces with 3D printing devices, CNC machines or industrial robots. Furthermore, according to some aspects of the present invention, the method 500, 1500 and corresponding system allows to design surfaces and generate ASGs that can adopt shapes that are beyond the possibilities of what existing technology can offer.

Manufacturing and Production Process

As explained above, method 500 or system CS can be part of a distributed manufacturing method 1500 as shown schematically and exemplarily in FIG. 2. The CAD object data can be provided at one data processing unit, for example server 50 that sends or otherwise makes available the CAD object data over network 40 to data processing unit 20 that has a computer software operating thereon performing method 500, including steps S200, S210, S220, and S230. Next, the manufacturing ready data is sent or otherwise made available by step S240 to another data processing unit 70, for example a device that is operating a commercial CAD, CAE or CAM software. In addition, the step of manufacturing S250 can be performed at another location.

As an exemplary industrial application, for example in the automotive industry such as for the production of cars, ships or aircrafts, the simulation of computational fluid dynamics is necessary in order to predict the physical behavior of a vehicle regarding a medium such as water, for example for ships and aquadynamic behavior, or air for example for cars and aircrafts and aerodynamic behavior. The physical quantities are expresses as numerical solutions and computed using the H-spline based stiffness matrix K and an H-spline based force vector F. An adaptive refinement of the solution allows to improve the accuracy to obtain simulations that are precise enough to manufacture prototypes of the vehicles that are first tested in real conditions before the models undergo serial production. In this case, once adaptive refinement is completed the solution surface SSF is converted into a mesh that will be used as input into manufacturing devices, typically CNC machines such as cutting lasers, that produce the different parts of the vehicle as for example the chassis of a car, a sub-part of a wing of an aircraft or a part belonging to the carcass of an aircraft or a ship. Similarly, in another exemplary situation instead of a CNC machine, the mesh obtained from the SSF will be input into a 3D printer as for example is the case in additive manufacturing to produce metal parts of vehicles or machines as well as industrial products.

In yet another exemplary situation involving the production of mechanical parts such as a break disk, a stress and heat analysis needs to be performed prior to manufacturing the disk. In this case, the numerical solution of the physical problem is again expressed in an H-spline based stiffness matrix K and an H-spline based force vector F prior to adaptive refinement and final mesh generation from the solution surface SSF. A similar physical problem needs to be studied to compute optimal heat dissipation along a surface, such as for example when manufacturing isolation parts to protect against temperature changes in buildings, aircrafts or cars.

While the invention has been disclosed with reference to certain preferred embodiments, numerous modifications, alterations, and changes to the described embodiments, and equivalents thereof, are possible without departing from the scope of the invention. Accordingly, it is intended that the invention not be limited to the described embodiments, and be given the broadest reasonable interpretation in accordance with the language of the appended claims.

1. A method for performing H-spline compatible isogeometric analysis (IGA) on a geometric object, the method being performed on a computer device having a memory, the method comprising the steps of:
creating an analysis suitable geometry (ASG) using H-splines from the geometric object, the geometric object being represented by H-splines;
storing the analysis suitable geometry (ASG) in the memory; and
performing the H-spline compatible IGA on the ASG stored in the memory of the computer device to generate the data the represents a stiffness matrix and a force vector of the H-spline compatible IGA.

2. The method according to claim 1, wherein the H-spline compatible IGA is numerically solved by generating a B-spline-based stiffness matrix K and a B-spline based force vector F in a cardinal B-spline basis.

3. The method according to claim 2, further comprising the step of:
converting the H-spline compatible IGA data represented in the cardinal B-spline basis into a representation using the H-splines to change a parameterization for compatibility with the geometric object; and
storing the representation using the H-splines in the memory.

4. The method according to claim 3, wherein the step of converting further comprises:
numerically changing the cardinal B-spline basis into the H-splines by the computer device.

5. The method according to claim 4, wherein the step of changing is performed in a lossless manner such that data representing the numerical IGA solution expressed in the cardinal B-spline basis remains unchanged when expressed with the H-splines.

6. The method according to claim 3, further comprising the step of:
refining data of at least one of the stiffness matrix and the force vector of the H-spline compatible IGA.

7. The method according to claim 6, wherein the step of refining includes matching a refinement level of the geometric object in the representation using the H-splines with a refinement level of the ASG data that uses H-splines.

8. The method according to claim 1, wherein the geometric object is a digital representation of a physical part,
the method further comprising the step of:
preparing a data presentation of the physical part for manufacturing based on the at least one of the stiffness matrix and the force vector of the H-spline compatible IGA.

9. The method according to claim 8, further comprising the step of:
manufacturing the physical part with a manufacturing machine.

10. A system for performing H-spline compatible isogeometric analysis (IGA) on a geometric object, the system including a computer device having a memory, the computer device configured to
create an analysis suitable geometry (ASG) using H-splines from the geometric object, the geometric object being represented by H-splines;
store the analysis suitable geometry (ASG) in the memory of the computer device; and
perform the H-spline compatible IGA on the ASG stored in the memory of the computer device to generate the data the represents a stiffness matrix and a force vector of the H-spline compatible IGA.

11. The system according to claim 10, wherein the H-spline compatible IGA is numerically solved by generating a B-spline-based stiffness matrix K and a B-spline based force vector F in a cardinal B-spline basis.

12. The system according to claim 11, wherein the computer device is further configured to
convert the H-spline compatible IGA data represented in the cardinal B-spline basis into a representation using the H-splines to change a parameterization for compatibility with the geometric object; and
store the representation using the H-splines in the memory of the computer device.

13. The system according to claim 12, wherein the converting of the H-spline includes a numerically changing of the cardinal B-spline basis into the H-splines by the computer device.

14. The system according to claim 13, wherein the numerically changing is performed in a lossless manner such that data representing the numerical IGA solution expressed in the cardinal B-spline basis remains unchanged when expressed with the H-splines.

15. The system according to claim 10, wherein the computer device is further configured to
refine data of at least one of the stiffness matrix and the force vector of the H-spline compatible IGA.

16. The system according to claim 15, wherein the refining data includes a matching of a refinement level of the geometric object in the representation using the H-splines with a refinement level of the ASG data that uses H-splines.

17. The system according to claim 10, wherein the geometric object is a digital representation of a physical part, and
wherein the computer device is further configured to
prepare a data presentation of the physical part for manufacturing based on the at least one of the stiffness matrix and the force vector of the H-spline compatible IGA.

18. The system according to claim 17, the system further comprising a manufacturing apparatus that is configured to manufacture the physical part based on the digital representation.

19. A non-transitory computer-readable medium having computer code recorded thereon, the computer code configured to perform a method for performing H-spline compatible isogeometric analysis (IGA) on a geometric object when the computer code is executed on a hardware computer having a memory, the method comprising the steps of:
creating an analysis suitable geometry (ASG) using H-splines from the geometric object, the geometric object being represented by H-splines;
storing the analysis suitable geometry (ASG) in the memory; and
performing the H-spline compatible IGA on the ASG stored in the memory of the computer device to generate the data the represents a stiffness matrix and a force vector of the H-spline compatible IGA.
